(19) United States
(12) Patent Application Publication
(10) Pub. No.: US 2024/0167807 A1
(43) Pub. Date: May 23, 2024

(54) OPTICAL TOMOGRAPHY SYSTEM AND METHOD OF USING

(71) Applicant: NEC CORPORATION, Tokyo (JP)

(72) Inventors: John Kenji David CLARK, Tokyo (JP); Shigeru NAKAMURA, Tokyo (JP)

(21) Appl. No.: 17/989,687

(22) Filed: Nov. 18, 2022

(51) Int. Cl. G01B 9/02091; G01B 9/02001

(52) U.S. Cl. CPC G01B 9/02091; G01B 9/02007

(57) ABSTRACT

A swept-source optical coherence tomography (SS-OCT) apparatus includes a wavelength-tunable light source, and a first optical coupler configured to split an output of the wavelength-tunable light source into a reference light beam and a sample light beam. The SS-OCT apparatus includes a sample illumination section configured to illuminate a sample using the sample beam, and receive a backscattered sample light beam. The SS-OCT apparatus includes a second optical coupler configured to receive the reference light beam and the backscattered sample light beam, and output an optical interference signal. The SS-OCT apparatus includes a detector configured to convert the optical interference signal to an electrical interference signal. The SS-OCT apparatus includes a controller configured to receive the electrical interference signal, generate a sparse representation based on the received electrical signal using compressed sensing, and generate a depth profile of the sample based on the sparse representation.

### RELATED APPLICATION

This application is related to U.S. application Ser. No. 17/876,453, filed Jul. 28, 2022, which is hereby incorporated by reference in its entirety.

### TECHNICAL FIELD

This description relates in general to an optical coherence tomography (OCT) system and a method of using the same.

### BACKGROUND

Optical Coherence tomography (OCT) is a technique for obtaining three-dimensional tomographic images of samples. In OCT, light from a light source is split into a sample light beam and a reference light beam, the sample light beam is focused onto a sample by an optical lens at an interrogated position in the plane transverse to the direction of light propagation. The backscattered light from the sample is collected and interfered with the reference light beam to produce an optical interference signal. The depth profile of the sample along the direction of light propagation at the position is then extracted from the optical interference signal. The exact means with which the depth profile is extracted depends on the OCT technique being used. A plurality of positions in the transverse plane are interrogated to obtain a three-dimensional depth profile of the sample, in other words a tomographic image.

Swept-Source OCT (SS-OCT) is an OCT technique that makes use of a light source with a tunable wavelength to extract depth profiles. For each interrogated position, the wavelength of the light source is swept across a wavelength range and the intensity of the optical interference signal is measured over the wavelength range. Sample light scattered from the sample will result in a sinusoidal oscillation in the intensity of the optical interference signal with a frequency that depends on the depth from which the light was scattered. The depth profile can therefore be extracted by calculating the Fourier transform of the measured optical interference signal intensity. Swept-source lasers whose wavelengths can be swept at rates of hundreds of kilohertz have enabled the acquisition of high-resolution tomographic images at high-speeds with SS-OCT and made SS-OCT the standard for many clinical and scientific applications.

### SUMMARY

The present description provides a SS-OCT apparatus for the acquisition of accurate tomographic images when a sample moves or sample light moves relative to a sample during scan acquisition. The SS-OCT apparatus is able to use a non-monotonic wavelength sweep and compressed sensing to extract two-dimensional depth profiles free of sample movement and sample light movement induced distortion.

An aspect of this description relates to a swept-source optical coherence tomography (SS-OCT) apparatus. The SS-OCT apparatus includes a wavelength-tunable light source. The SS-OCT apparatus includes a first optical coupler configured to split an output of the wavelength-tunable light source into a reference light beam and a sample light beam. The SS-OCT apparatus includes a sample illumination section configured to illuminate a sample using the sample beam, and receive a backscattered sample light beam that is backscattered from the sample. The SS-OCT apparatus includes a second optical coupler configured to receive the reference light beam and the backscattered sample light beam, wherein the second optical coupler is configured to output an optical interference signal. The SS-OCT apparatus further includes a detector configured to convert the optical interference signal to an electrical interference signal. The SS-OCT apparatus further includes a controller configured to receive the electrical interference signal, use compressed sensing to generate a sparse representation based on the received electrical signal, and generate a depth profile of the sample based on the sparse representation.

An aspect of this description relates to a swept-source optical coherence tomography (SS-OCT) apparatus. The SS-OCT apparatus includes a wavelength-tunable light source. The SS-OCT apparatus further includes a first optical coupler configured to split an output of the wavelength-tunable light source into a reference light beam and a sample light beam. The SS-OCT apparatus further includes a sample illumination section configured to illuminate a sample using the sample beam, and receive a backscattered sample light beam that is backscattered from the sample. The SS-OCT apparatus further includes a second optical coupler configured to receive the reference light beam and the backscattered sample light beam, wherein the second optical coupler is configured to output an optical interference signal. The SS-OCT apparatus further includes a detector configured to convert the optical interference signal to an electrical interference signal. The SS-OCT apparatus further includes a controller configured to receive the electrical interference signal, and non-monotonically sweep an output wavelength of the wavelength-tunable light source.

An aspect of this description relates to a method of using a swept-source optical coherence tomography (SS-OCT) apparatus. The method includes outputting a beam using a wavelength-tunable light source. The method further includes splitting the beam into a reference light beam and a sample light beam. The method further includes illuminating a sample using the sample beam. The method further includes receiving a backscattered sample light beam that is backscattered from the sample. The method further includes interfering the reference light beam and the backscattered sample light beam to form an optical interference signal. The method further includes converting the optical interference signal to an electrical interference signal. The method further includes generating a sparse representation based on the electrical signal using compressed sensing. The method further includes generating a depth profile of the sample based on the sparse representation.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a cross-sectional view of a sample illumination section of a Swept-Source Optical Coherence tomography (SS-OCT) apparatus illuminating a sample having an interface that is inclined relative to a plane transverse to an optical axis of a scan lens of a SS-OCT apparatus according to some embodiments.

FIG. 1B is a view of interference signals obtained from a sample having an interface that is inclined relative to a plane transverse to an optical axis of a scan lens of a SS-OCT apparatus according to some embodiments.

FIG. 1C is a view of depth profiles extracted from interference signals obtained from a sample having an interface that is inclined relative to a plane transverse to an optical axis of a scan lens of a SS-OCT apparatus according to some embodiments.

FIG. 2A is a view of a two-dimensional interference signal obtained from a sample having an interface that is inclined relative to a plane transverse to an optical axis of a scan lens of a SS-OCT apparatus measured over a distance in a transverse direction of a plane transverse to an optical axis of a scan lens of the SS-OCT apparatus according to some embodiments.

FIG. 2B is a view of a sample of a two-dimensional interference signal obtained from a sample having an interface that is inclined relative to a plane transverse to an optical axis of a scan lens when an output wavelength of a light source is swept monotonically as a sample light beam is scanned in a transverse direction according to some embodiments.

FIG. 2C is a view of an interference signal obtained from a sample having an interface that is inclined relative to a plane transverse to an optical axis of a scan lens when an output wavelength of a light source is swept monotonically as a sample light beam is scanned in a transverse direction according to some embodiments.

FIG. 2D is a view of a depth profile extracted from an interference signal obtained from a sample having an interface that is inclined relative to a plane transverse to an optical axis of a scan lens when an output wavelength of a light source is swept monotonically as a sample light beam is scanned in a transverse direction according to some embodiments.

FIG. 2E is a view of a sample of a two-dimensional interference signal obtained from a sample having an interface that is inclined relative to a plane transverse to an optical axis of a scan lens when an output wavelength of a light source is swept non-monotonically as a sample light beam is scanned in a transverse direction according to some embodiments.

FIG. 2F is a view of an interference signal obtained from a sample having an interface that is inclined relative to a plane transverse to an optical axis of a scan lens when an output wavelength of a light source is swept non-monotonically as a sample light beam is scanned in a transverse direction according to some embodiments.

FIG. 2G is a view of a depth profile extracted from an interference signal obtained from a sample having an interface that is inclined relative to a plane transverse to an optical axis of a scan lens when an output wavelength of a light source is swept non-monotonically as a sample light beam is scanned in a transverse direction according to some embodiments.

FIG. 3A is a view of a relationship between injection currents and output wavelength of a semiconductor wavelength-tunable laser according to some embodiments.

FIG. 3B is a view of a sequence of injection currents of a semiconductor wavelength-tunable laser with minimal sudden changes in current according to some embodiments.

FIG. 3C is a view of a non-monotonic wavelength sweep of an output wavelength of a semiconductor wavelength-tunable laser when injection current sequences with minimal sudden changes in current are used according to some embodiments.

FIG. 4A is a view of a sample of a two-dimensional interference signal obtained from a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments.

FIG. 4B is a view of a sample of an interference signal obtained from a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments.

FIG. 4C is a view of a depth profile extracted from an interference signal obtained from a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments.

FIG. 5A is a view of a two-dimensional depth profile extracted from a two-dimensional interference signal obtained from a sample having an interface that is inclined relative to a plane transverse to an optical axis of a scan lens of a SS-OCT apparatus measured over a distance in a transverse direction of a plane transverse to an optical axis of a scan lens of the SS-OCT apparatus according to some embodiments.

FIG. 5B is a view of a sparse representation of a two-dimensional depth profile extracted from a two-dimensional interference signal obtained from a sample having an interface that is inclined relative to a plane transverse to an optical axis of a scan lens of a SS-OCT apparatus measured over a distance in a transverse direction of a plane transverse to an optical axis of a scan lens of the SS-OCT apparatus according to some embodiments.

FIG. 6A is a view of a sparse representation extracted by compressed sensing of a two-dimensional depth profile of a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments.

FIG. 6B is a view of a two-dimensional depth profile reconstructed from a sparse representation extracted by compressed sensing of a two-dimensional depth profile of a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments.

FIG. 7A is a view of the wavenumber of the output of a light source with a tunable wavelength during a non-monotonic wavelength sweep where the wavenumber increases and decreases according to some embodiments.

FIG. 7B is a view of an interference signal obtained from a sample having an interface that is inclined relative to a plane transverse to an optical axis of a scan lens when a light source with a tunable wavelength is swept such that the wavenumber of an output increases and decreases as a sample light beam is scanned in a transverse direction according to some embodiments.

FIG. 7C is a view of a sparse representation extracted by compressed sensing of a two-dimensional depth profile of a sample having an interface that is inclined relative to a plane transverse to an optical axis of a scan lens when a light source with a tunable wavelength is swept such that the wavenumber of an output increases and decreases as a sample light beam is scanned in a transverse direction according to some embodiments.

FIG. 7D is a view of a two-dimensional depth profile reconstructed from a sparse representation extracted by compressed sensing of a two-dimensional depth profile of a sample having an interface that is inclined relative to a plane transverse to an optical axis of a scan lens when a light source with a tunable wavelength is swept such that the wavenumber of an output increases and decreases as a sample light beam is scanned in a transverse direction according to some embodiments.

FIG. 8 is a schematic view of a SS-OCT apparatus in accordance with some embodiments.

FIG. 9 is a flowchart of a method of using an SS-OCT apparatus in accordance with some embodiments.

FIG. 10 is a schematic view of a controller for extracting a depth profile based on information from an SS-OCT apparatus using a non-monotonic wavelength sweep, a sparse representation and compressed sensing in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

While swept light sources are usable in combination with compressed sensing in order to obtain precise information related to sample depth at a specific location, obtaining depth profile information across a sample is more difficult. In order to obtain a depth profile across a sample, the sample is moved relative to an incident light as an interference signal is measured. In some embodiments, the sample is moved in a plane transverse to an optical path of the light source, e.g., using moveable stage. In some embodiments, the incident light moves in a plane transverse to an optical path of the incident light across the sample, e.g., using one or more movable lenses or mirrors. Unfortunately, bandwidth limitations of the mechanical components used to scan the sample light beam in the transverse direction degrade the quality and accuracy of the extracted depth profiles and limit the transverse scan speed. In one approach, the sample light beam would be discretely moved to each interrogated position in the transverse plane each time the wavelength of the light source is swept and the optical interference signal would be measured at this fixed position. However, the mechanical beam scanning optics used to scan the sample light beam in OCT are generally limited to bandwidths of hundreds of hertz (Hz) to several kilohertz (kHz), and as such the mechanical beam scanning optics cannot discretely change the position at the hundreds of kilohertz (kHz) rates of swept-source lasers. The sample light beam position is therefore scanned continuously over the transverse plane in a raster-scan pattern in an OCT system, making the transverse position interrogated by the sample light beam different at the beginning and end of a wavelength sweep. If the depth of a scattering interface within the sample changes in the transverse direction, then the depth profile extracted, e.g., using the Fourier transform, will have scattering peaks that are broadened and shifted from the true scattering peak positions in the real sample. This limits the speed at which the sample light beam is able to be scanned, as faster scan speeds will increase the distance between the transverse position at the beginning and end of a wavelength sweep, thus exacerbating the impact on the quality of the extracted depth profile. The slow scanning speed also reduces throughput for sample analysis.

The phenomenon described above also restricts the manner in which the wavelength of the light source is able to be swept. If a non-monotonic wavelength sweep is used, the changing depth profile in the transverse direction will cause the optical interference signal to show discontinuities when plotted in wavenumber space. This will result in significant noise and false peaks in depth profiles extracted, e.g., using the Fourier transform. A non-monotonic wavelength sweep is where the wavelength of the light source does not continuously increase or decrease during a wavelength sweep during a single interrogation of a sample.

The present description provides a SS-OCT apparatus for the acquisition of accurate tomographic images when a sample moves or sample light moves relative to a sample during scan acquisition. The apparatus makes use of a non-monotonic wavelength sweep and compressed sensing to extract two-dimensional depth profiles with reduced distortions resulting from sample movement or sample light movement.

In SS-OCT, a one-dimensional depth profile is extracted at each position in the transverse plane by measuring an intensity of an optical interference signal created by the interference between a reference light beam and a backscattered sample light beam while the wavelength of a light source with a tunable wavelength is swept across a wavelength range and then calculating the Fourier transform of the optical interference signal intensity. The one-dimensional depth profile analysis relies on an assumption that the position being probed and the depth profile of the sample is the same at the beginning and end of the wavelength sweep. If, however, the depth profile changes during the wavelength sweep, for example because the sample light used to interrogate the sample is being scanned across the sample during the wavelength sweep, then the depth profile extracted using the Fourier transform will be distorted from the true depth profile of the sample. When a monotonic wavelength sweep is used, the distortion will manifest as broadening and shifting of the scattering peaks in the depth profile. If the sweep is non-monotonic, additional false peaks and noise will appear in the extracted depth profile. Because of these false peaks, other approaches use monotonic wavelength sweeps. However, another problem with monotonic wavelength sweeps is that the maximum speed at which the sample light is able to be scanned across the sample and obtain reasonably precise depth profiles is limited.

This description helps to overcome this limitation of SS-OCT through the use of a non-monotonic wavelength sweep and compressed sensing to extract two-dimensional depth profiles of a sample for each wavelength sweep. Compressed sensing is a technique to accurately reconstruct a signal from a limited number of measurements of the signal by finding a representation of the signal in a domain where the signal is sparse. The technique is also usable to directly find a sparse representation of the signal when the sparse representation is of interest. The relation between a signal and a corresponding sparse representation is described by the linear system of equations in Equation (1),

y=Ax, (1)

where y is the signal, x is the sparse representation, and A is a transformation matrix that transforms a vector from the sparse domain to the signal domain. If the signal is measured at a sub-set of values, yₛ, then the sparse representation of the signal is related to the sub-set of values according to Equation (2),

yₛ=Aₛx, (2)

where Aₛ is a sub-set of A. If yₛ has fewer elements than x, then the system is underdetermined and cannot be solved uniquely. However, since x is known to be sparse, finding x by finding a sparsest solution that satisfies Equation 2 is possible. One method of achieving this is by using the least-absolute shrinkage and selection operator (LASSO), as described by Equation (3),

$$min \frac{1}{2} {‖ ( {A}_{s} x - {y}_{s} ‖}_{2}^{2} + α {‖ x ‖}_{1} . \qquad ( 3 )$$

where α, a Lagrangian multiplier, is a parameter that allows for noise in the measured signal. The x that minimizes Equation (3) is the sparse approximation of y. Once x has been obtained, y is able to be reconstructed by applying the transformation matrix A to the sparse approximation according to Equation 1.

The depth profile of most samples is sparse, and therefore, the intensity of the optical interference signal and the depth profile are able to be treated as a signal, and a corresponding sparse representation, respectively, with the transformation matrix that transforms the sparse depth profile to the interference signal domain being the inverse Fourier transform.

In some embodiments of the present description, the use of compressed sensing is expanded to a second spatial or temporal dimension that represents the transverse position or time at which the signal was acquired. The signal becomes a two-dimensional interference signal, w, with the first axis corresponding to the wavenumber of the light source and the second axis corresponding to the transverse position or time at which the interference signal is measured. In this way, each column of the signal w represents the interference signal that would be measured if the wavelength was swept instantaneously at each transverse position or point in time. If a sparsifying transform, for example the Fourier transform, is applied to the signal w along the first wavenumber axis, the resulting depth profile x will be sparse in the first axis, but the resulting depth profile will not be sparse in a second axis, perpendicular to the first axis. To obtain a two-dimensionally sparse representation, v, a second sparsifying transform is applied along the second axis. Mathematically, the relation between w and v is described by Equation (4),

w=(B⊗A)v, (4)

where w and v are flattened into one-dimensional vectors and B⊗A is the Kronecker product of the inverse of the first sparsifying transform and the inverse of the second sparsifying transform, hereafter defined as C. The wavelength of a light source with a tunable wavelength is swept non-monotonically such that a subset of w, wₛ is measured. As wₛ and v are related by Equation (5),

wₛ=Cₛv, (5)

v is able to be extracted using the LASSO as described above. Finally, the two-dimensional depth profile, z, with a first axis corresponding to depth and a second axis corresponding to a transverse position or time is reconstructed by applying the inverse of the second sparsifying transform, as described by Equation (6),

z=Bv. (6)

Since the present description accounts for the change in the depth profile and interference signal during a single wavelength sweep, the extraction of depth profiles free from distortion caused by movement of the sample light beam or sample is possible.

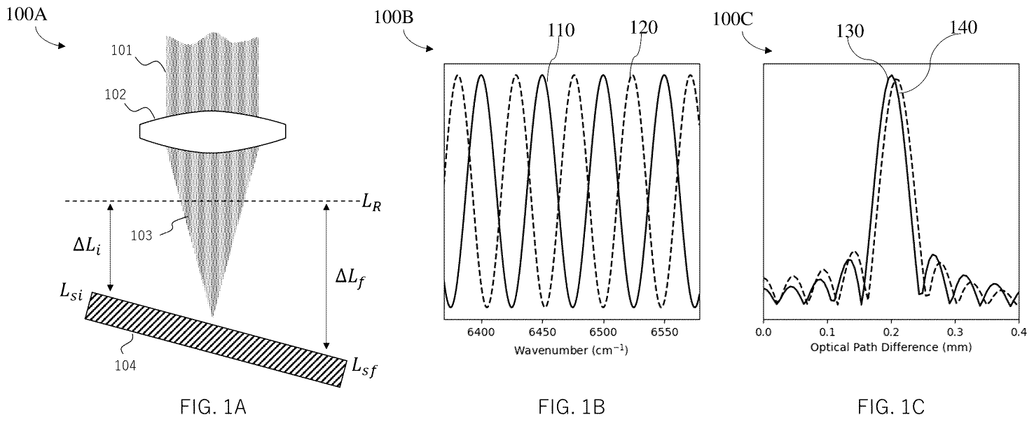

FIGS. 1A-C describe a situation where an SS-OCT apparatus is used to acquire depth profiles from a sample having an interface inclined relative to the transverse plane of the optical axis of a scan lens of the SS-OCT apparatus.

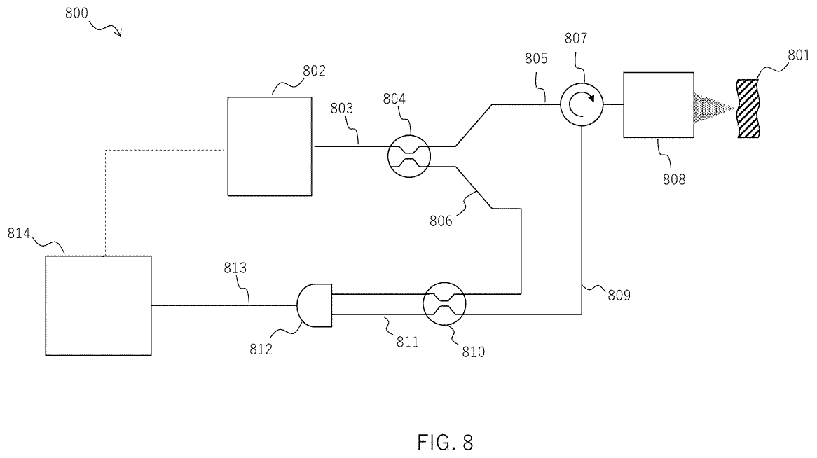

FIG. 1A is a schematic diagram of a sample illumination section 100A of an SS-OCT apparatus when a sample is inclined relative to the transverse plane of the SS-OCT apparatus. A scan collimated sample light beam 101 is focused by a scan lens 102 into a focused sample light beam 103 that is incident on an inclined sample 104 having an inclined interface. In some embodiments, the inclined interface is a single scattering interface of the sample 104. The inclined sample 104 with a single scattering interface is inclined relative to the transverse plane of the scan lens 102 such that the light traversing the sample illumination section of the SS-OCT apparatus has an initial optical path length Lₛᵢ at an initial transverse position and a final optical path length L_{sf} at a final transverse position. The initial optical path length differs from a reference optical path length L_{R} of light traversing a reference light section of the SS-OCT apparatus by an initial optical path length difference ΔLᵢ. The final optical path length differs from a reference optical path length L_{R} of light traversing a reference light section of the SS-OCT apparatus by a final optical path length difference ΔL_{f}. The focused sample light beam 103 is scattered by the sample 104 and the backscattered light is collected by the scan lens 102 and interfered with a reference light beam that traverses the reference light section of the SS-OCT apparatus to form an optical interference signal. The backscattered light and the reference light beam have an optical path difference ΔL that results in the intensity of the optical interference signal, hereafter referred to simply as an interference signal, varying sinusoidally with the wavelength of the sample light beam and the reference light beam. In some embodiments, the illumination section 100A is part of an SS-OCT apparatus 800 (FIG. 8). One of ordinary skill in the art would understand that while the terms “initial” and “final” are used in the description of the illumination section 100A, these locations are not required to be a beginning or ending point of a scan performed using the illumination section 100A. One of ordinary skill in the art would understand that, in some embodiments, portions of the sample 104 outside of that explicitly shown in FIG. 1A are perpendicular to the transverse plane of the scan lens 102, i.e., the optical path length difference is constant over a portion of the sample 104 outside of the portion in FIG. 1A.

FIG. 1B is a view of interference signals 100B obtained from a sample having an interface that is inclined relative to a plane transverse to an optical axis of a scan lens of a SS-OCT apparatus according to some embodiments. Returning to FIG. 1A, if the sample light beam 103 illuminates the sample 104 at the initial transverse position, the backscattered light and the reference light have an optical path difference ΔLᵢ. The interference signal obtained when the backscattered light is interfered with the reference light beam is given by the solid line 110 in FIG. 1B. If the sample light beam 103 illuminates the sample 104 at the final transverse position, the backscattered light and the reference light have an optical path difference ΔL_{f}. The interference signal obtained when the backscattered light is interfered with the reference light beam is given by the dashed line 120 in FIG. 1B.

FIG. 1C is a view of depth profiles 100C extracted from interference signals obtained from a sample having an interface that is inclined relative to a plane transverse to an optical axis of a scan lens of a SS-OCT apparatus according to some embodiments. The Fourier transform is applied to the interference signal, e.g., solid line 110 (FIG. 1B), obtained from the initial transverse position to produce a depth profile of the initial transverse position given by the solid 130 line in FIG. 1C. The Fourier transform is applied to the interference signal, e.g., dashed line 120 (FIG. 1B), obtained from the final transverse position to produce a depth profile of the final transverse position given by the dashed line 140 in FIG. 1C. The depth profiles extracted from the initial and final transverse positions have strong peaks at the optical path length difference corresponding to the initial optical path length difference ΔLᵢ and final path length difference ΔL_{f}, respectively.

The description of FIGS. 1A-C is based on an assumption that while the interference signal of a transverse position is being measured, by sweeping the wavelength of a light source of an SS-OCT apparatus, the transverse position and depth profile of the sample did not change. In a practical OCT system, however, the sample light beam is scanned continuously in the transverse direction, moving from an initial transverse position to a final transverse position during a single wavelength sweep. This results in the interference signal changing during the wavelength sweep, for example, when the sample is a sample described by FIG. 1A, the interference signal will change from the solid line 110 of FIG. 1B to the dashed line 120 of FIG. 1B during the wavelength sweep. This distorts the interference signal 100B and makes the accurate extraction of a depth profile 100C difficult and/or reduces the accuracy of the depth profile 100C.

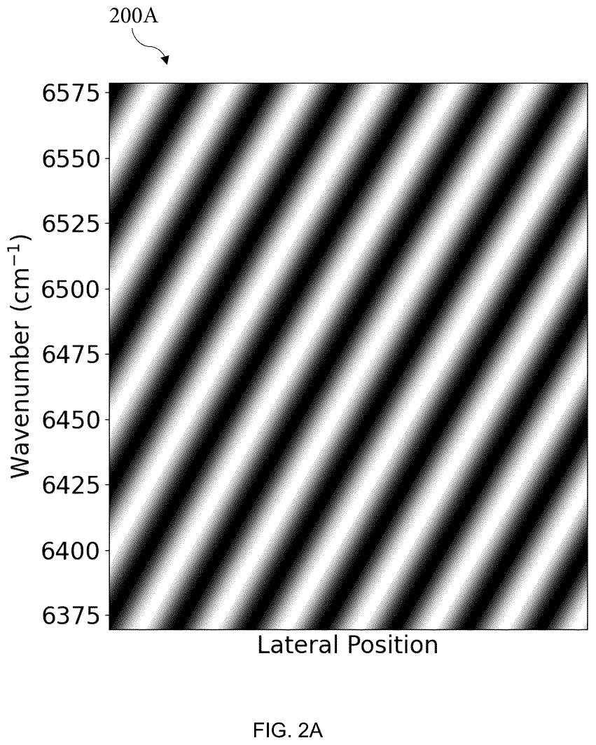

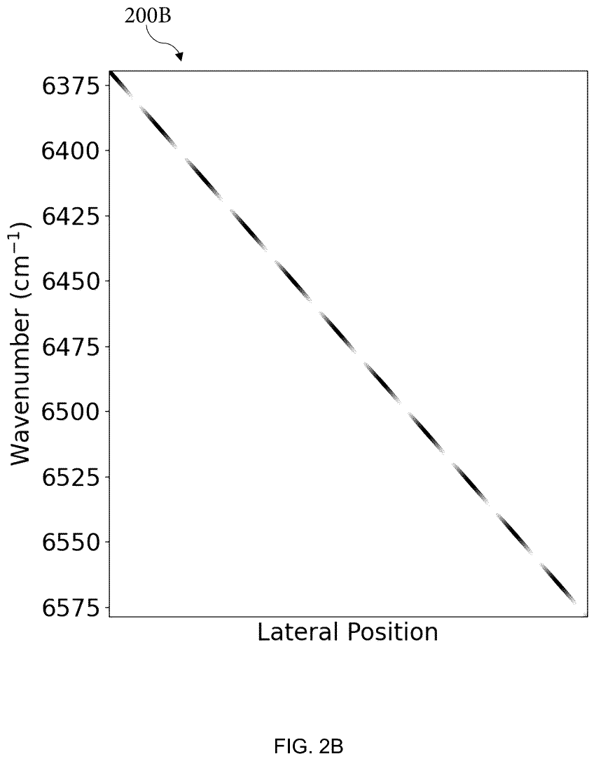

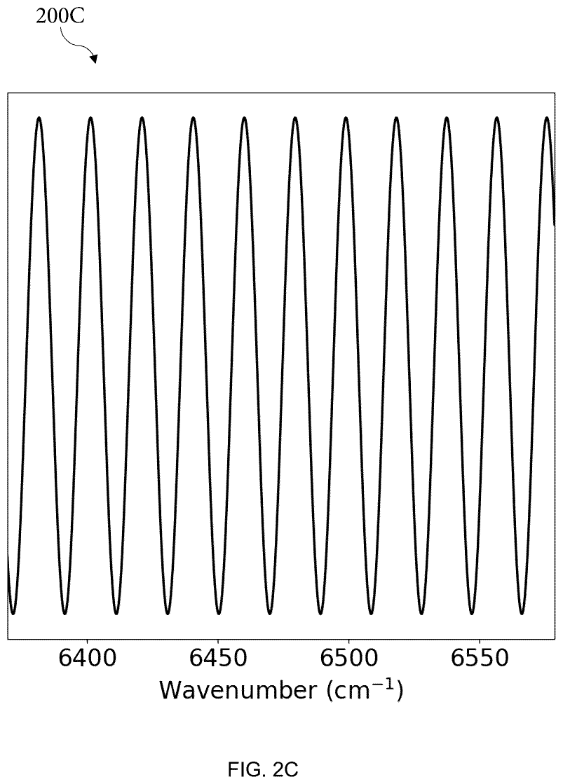

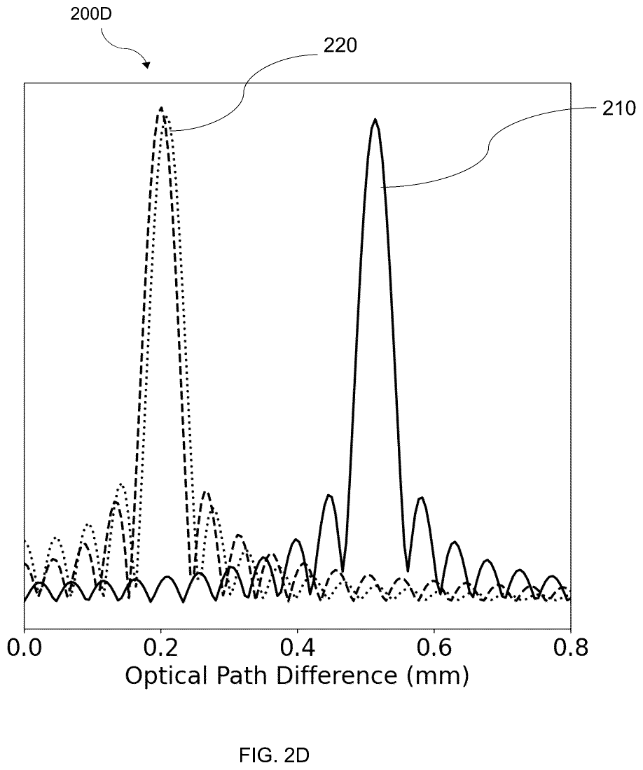

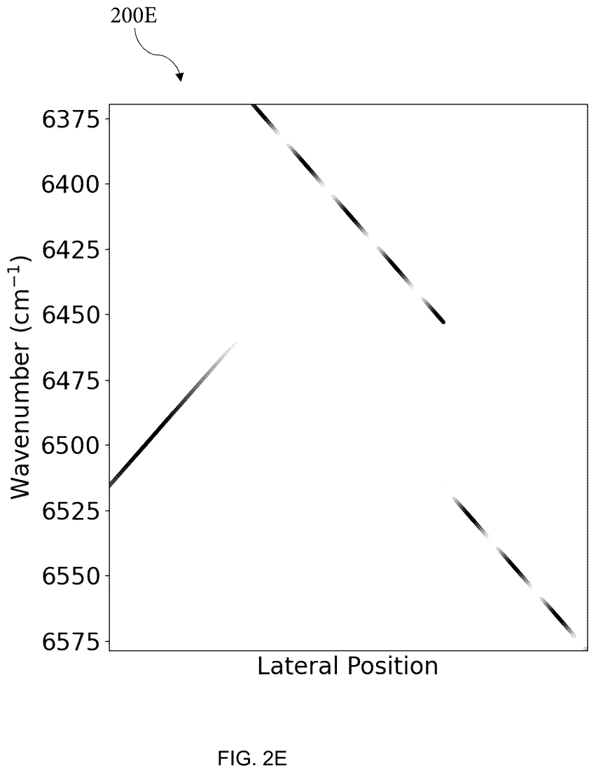

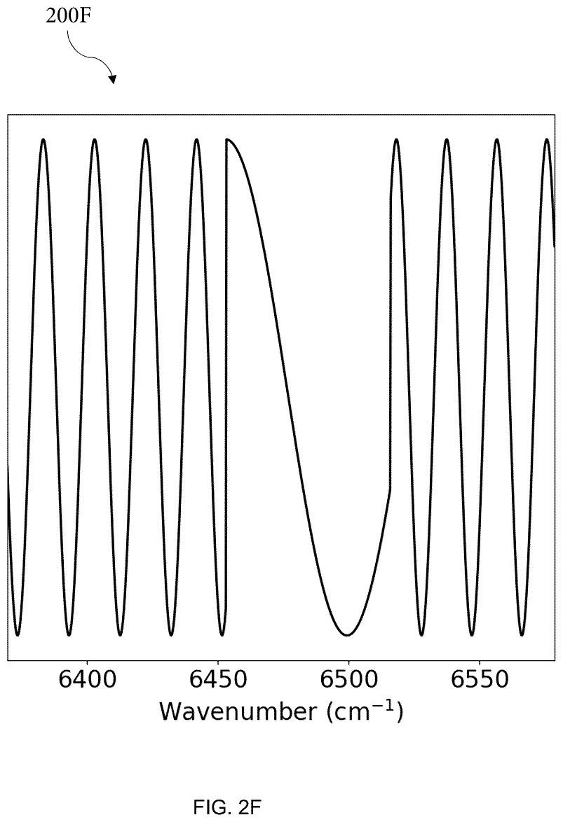

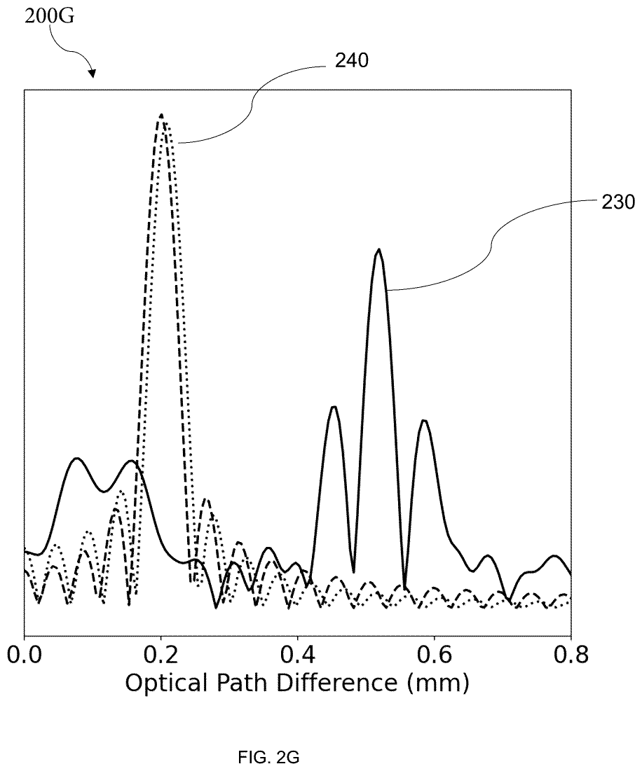

FIGS. 2A-2G relate to an example of distortion induced by movement of a sample light beam or change in a sample depth profile during a wavelength sweep of a light source of an SS-OCT apparatus.

FIG. 2A is a view of a two-dimensional interference signal 200A obtained from a sample having an interface that is inclined relative to a plane transverse to an optical axis of a scan lens of a SS-OCT apparatus measured over a distance in a transverse direction of a plane transverse to an optical axis of a scan lens of the SS-OCT apparatus according to some embodiments. When the optical path length of a scattering interface changes in the transverse direction, the interference signal will change with the transverse position, e.g., as described below with respect to FIG. 2A. When a sample light beam of a SS-OCT apparatus is scanned in the transverse direction at the same time the wavelength of a light source of the SS-OCT apparatus is swept, only a portion of the two-dimensional interference signal is measured.

FIG. 2B is a view of a portion of a two-dimensional interference signal 200B obtained from a sample having an interface that is inclined relative to a plane transverse to an optical axis of a scan lens when an output wavelength of a light source is swept monotonically as a sample light beam is scanned in a transverse direction according to some embodiments. When an output wavelength of a light source of a SS-OCT apparatus is swept monotonically as a sample light beam is scanned in a transverse direction, an example of a portion of the two-dimensional interference signal obtained is shown in FIG. 2B according to some embodiments. The portion only represents a very small fraction of the two-dimensional interference signal. Comparing the two-dimensional interference signal 200A with the two-dimension interference signal 200B, one of ordinary skill in the art would readily recognize that most of the information in the two-dimensional interference signal 200A is not included in the two-dimensional interference signal 200B.

FIG. 2C is a view of an interference signal 200C obtained from a sample having an interface that is inclined relative to a plane transverse to an optical axis of a scan lens when an output wavelength of a light source is swept monotonically as a sample light beam is scanned in a transverse direction according to some embodiments. The interference signal measured when an output wavelength of a light source is swept monotonically as a sample light beam is scanned in a transverse direction plotted in wavenumber space appears as in FIG. 2C. One of ordinary skill in the art would understand that the frequency of the sinusoidal oscillation in FIG. 2C is not the same as the frequency in the wavenumber axis of the sinusoidal oscillations of FIG. 2A. As a result, one of ordinary skill in the art would expect that the depth profile extracted from the interference signal 200C will not match the true depth profile of the sample interrogated to obtain the two-dimensional interference signal 200A.

FIG. 2D is a view of a depth profile 200D extracted from the interference signal 200C obtained from a sample having an interface that is inclined relative to a plane transverse to an optical axis of a scan lens when an output wavelength of a light source is swept monotonically as a sample light beam is scanned in a transverse direction according to some embodiments. When the Fourier transform is applied to the measured interference signal 200C of FIG. 2C, a depth profile 200D given by the solid line 210 in FIG. 2D is obtained. The actual depth profiles for the initial transverse position and final transverse position are given by the dashed and dotted lines 220, respectively. Since the dashed lines and the dotted lines are so similar, the dashed and dotted lines will be referred to as dashed line 220. One of ordinary skill in the art would understand that the optical path difference of the depth profile 200D extracted from the interference signal 200C of FIG. 2C neither matches the depth profile of the initial transverse position nor the depth profile of the final transverse position as shown by dashed line 220. The depth profile of the solid line 210 is significantly shifted from the depth profile of the dashed line 220.

The distortion in the depth profile in FIG. 2D is even more significant when a non-monotonic wavelength sweep is used as discussed in FIGS. 2E-2G.

FIG. 2E is a view of a sample of a two-dimensional interference signal 200E obtained from a sample having an interface that is inclined relative to a plane transverse to an optical axis of a scan lens when an output wavelength of a light source is swept non-monotonically as a sample light beam is scanned in a transverse direction according to some embodiments. Similar to FIG. 2B, the two-dimensional interference signal 200E includes only a very small portion of the two-dimensional interference signal 200A of FIG. 2A. Additionally, the wavenumber of the light source changes non-monotonically with sudden jumps in wavenumber as the transverse position of the sample light beam is scanned.

FIG. 2F is a view of an interference signal 200F obtained from a sample having an interface that is inclined relative to a plane transverse to an optical axis of a scan lens when an output wavelength of a light source is swept non-monotonically as a sample light beam is scanned in a transverse direction according to some embodiments. FIG. 2F shows the interference signal 200F obtained when the portion of the two-dimensional interference signal 200E given in FIG. 2E is plotted in wavenumber space. The sudden changes in wavenumber during the wavelength sweep result in sudden jumps in the interference signal, as seen by the distortion in the periodicity of the sinusoidal wave in the interference signal 200F. The frequency of sinusoidal oscillations in the interference signal also depends on the direction and rate at which the wavenumber changes relative to the transverse position.

FIG. 2G is a view of a depth profile 200G extracted from the interference signal 200F obtained from a sample with a single scattering interface that is inclined relative to a plane transverse to an optical axis of a scan lens when an output wavelength of a light source is swept non-monotonically as a sample light beam is scanned in a transverse direction according to some embodiments. When the Fourier transform is applied to the interference signal 200F of FIG. 2F, the depth profile 200G given by the solid line 230 in FIG. 2G is obtained. The depth profiles of the initial transverse position and final transverse position are given by the dashed and dotted lines 240, respectively. Since the dashed lines and the dotted lines are so similar, the dashed and dotted lines will be referred to as dashed line 240. The depth profile 200G indicates significant distortion with several false peaks in the solid line 230. Further, the solid line 230 is significantly shifted from the peak of the dashed line 240. The distortion in the depth profile 200G is even more pronounced than the depth profile 200D where a monotonic wavelength sweep was used. These significant distortions indicate that the extraction of an accurate depth profile is difficult when a non-monotonic wavelength sweep is used.

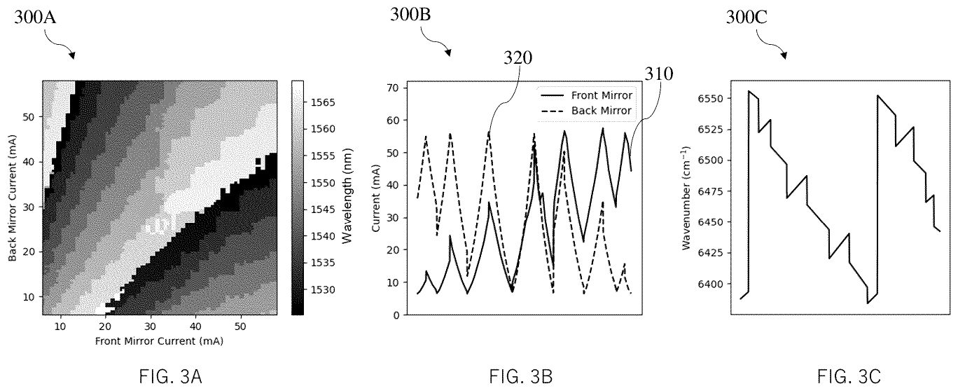

Despite the difficulty in obtaining accurate depth profiles using an SS-OCT apparatus that uses a light source with a non-monotonic wavelength sweep, non-monotonic sweeps are desirable in certain circumstances and methods of obtaining accurate depth profiles when a non-monotonic wavelength sweep is used are needed. FIGS. 3A-3C provide at least one example where the use of a non-monotonic wavelength sweep is desirable, for example, when a semiconductor wavelength-tunable laser is used as a light source.

FIG. 3A is a view of a relation 300A between the injection currents and output wavelength of a semiconductor wavelength-tunable laser. In some embodiments, the semiconductor wavelength-tunable laser usable for SS-OCT includes a sampled grating distributed Bragg reflector (SGDBR) laser. An output wavelength of a SGDBR laser is tuned by adjusting the current injected into front and back mirrors of the SGDBR laser. FIG. 3A is a view of an example of how the wavelength of a SGDBR laser changes with the injection currents. The injection currents and output wavelength are not linearly related. Therefore, sweeping the wavelength of the laser monotonically results in sudden changes in current. Since the bandwidths of electronic circuits used to control the injection currents are limited, higher speed wavelength sweeps are achievable if the output wavelength of a SGDBR laser is swept non-monotonically in a way that helps to reduce sudden changes in the injection currents.

FIG. 3B is a view of a sequence of injection currents 300B of a semiconductor wavelength-tunable laser with reduced sudden changes in current. For the SGDBR laser with the current to wavelength relation described in FIG. 3A, a front mirror current sequence 310 and a rear mirror current sequence 320 given in FIG. 3B allow the wavelength to be tuned across a telecommunications C-band non-monotonically.

FIG. 3C is a view of a non-monotonic wavelength sweep 300C of an output wavelength of a semiconductor wavelength-tunable laser when injection current sequences with minimal sudden changes in current are used according to some embodiments. For the SGDBR laser with the current to wavelength relation described in FIG. 3A, the output wavelength 300C of the SGDBR laser is swept in a sequence given by FIG. 3C when the front and rear mirror current sequences are tuned according to FIG. 3B. The output wavelength changes non-monotonically with several sudden changes in the output wavelength.

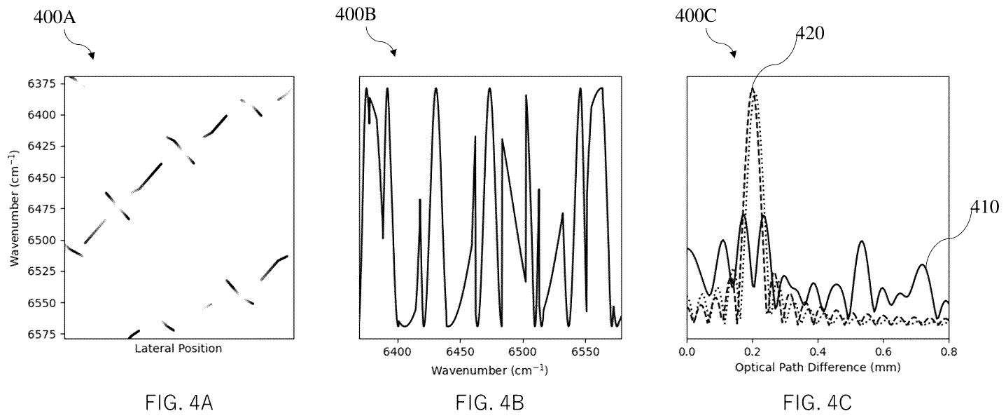

FIGS. 4A-4C demonstrate the difficulty in extracting an accurate depth profile when the wavelength of a light source of a SS-OCT apparatus is swept non-monotonically as a sample light beam of the SS-OCT apparatus is scanned in a transverse direction.

FIG. 4A is a view of a sample of a two-dimensional interference signal 400A obtained from a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments. The SGDBR laser with a current to output wavelength described by FIG. 3A is swept such that the output wavelength of the SGDBR laser changes according to FIG. 3C. The output wavelength is then used to obtain an interference signal from a sample with a two-dimensional interference signal given by FIG. 2A. Then a portion of the two-dimensional interference signal shown in FIG. 4A is obtained.

FIG. 4B is a view of a sample of an interference signal 400B obtained from a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments. The portion of a two-dimensional interference signal 400A shown in FIG. 4A plotted in wavenumber space yields the interference signal 400B shown in FIG. 4B. In some embodiments, the sample only has a single interface, which means that the interference signal should vary sinusoidally. However, the non-monotonic wavelength sweep and changing transverse position of the sample light beam during a wavelength sweep results in an interference signal 400B that does not consistently vary sinusoidal.

FIG. 4C is a view of a depth profile 400C extracted from the interference signal 400B obtained from a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments. A solid line 410 in FIG. 4C shows the depth profile extracted from the interference signal of FIG. 4B using the Fourier transform. The dashed and dotted lines 420 are the depth profiles of the initial transverse position and final transverse position, respectively. Since the dashed lines and the dotted lines are so similar, the dashed and dotted lines will be referred to as dashed line 420. The use of a non-monotonic wavelength sweep, movement of the sample light beam, and resulting change in the interference signal during the wavelength sweep causes the depth profile of the solid line 410 extracted to vary greatly from the true depth profile of the dashed line 420 with many false peaks and increased noise.

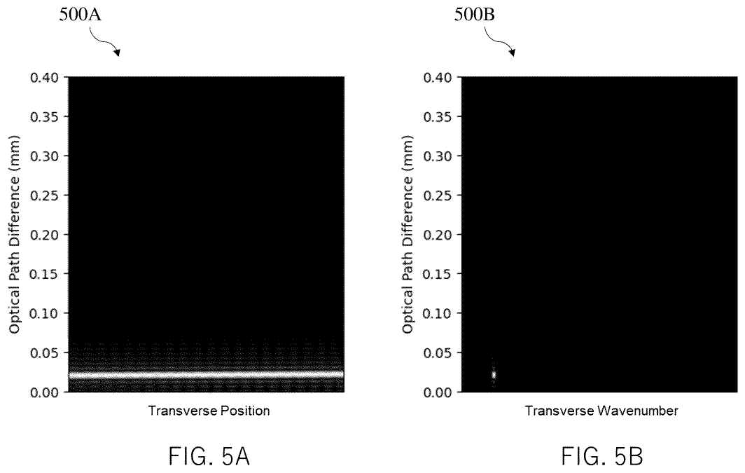

The difficulty in extracting accurate depth profiles from interference signals measured as a sample light beam is scanned in a transverse direction while the wavelength of a light source of a SS-OCT apparatus is swept is a result of the fact that the interference signal is different at different horizontal positions, at least partially because the depth profile is being treated as the same when the depth profile is extracted with the Fourier transform. To accurately extract the depth profiles, the change of the interference signal in the transverse direction and the full two-dimensional interference signal should be accounted for. FIG. 5A-AB are views of an accurate depth profile and indicate how to obtain an accurate depth profile through the use of compressed sensing according to some embodiments.

FIG. 5A is a view of a two-dimensional depth profile 500A extracted from a two-dimensional interference signal obtained from a sample having an interface that is inclined relative to a plane transverse to an optical axis of a scan lens of a SS-OCT apparatus measured over a distance in a transverse direction of a plane transverse to an optical axis of a scan lens of the SS-OCT apparatus according to some embodiments. When a two-dimensional interference signal obtained from a sample having an interface inclined relative to a plane transverse to an optical axis of a scan lens of a SS-OCT apparatus, as shown by FIG. 2A, is transformed along the wavenumber axis using the Fourier transform, the two-dimensional depth profile shown in FIG. 5A is obtained. When the transverse position of the sample light beam is scanned in the transverse direction as the wavelength of a light source of the SS-OCT apparatus is swept, however, only a portion of the two-dimensional interference signal, such as the portions in FIGS. 2B, 2E and 4A, is obtained and the two-dimensional depth profile of FIG. 5A is not able to be extracted directly from these limited portions using the Fourier transform. However, the two-dimensional depth profile has a sparse representation in a sparse domain which is able to be extracted from the depth profile by applying a sparsifying transform. In some embodiments, the sparsifying transform is the Fourier transform, and the sparse domain is the transverse wavenumber domain.

FIG. 5B is a view of a sparse representation 500B of a two-dimensional depth profile extracted from a two-dimensional interference signal obtained from a sample having an interface that is inclined relative to a plane transverse to an optical axis of a scan lens of a SS-OCT apparatus measured over a distance in a transverse direction of a plane transverse to an optical axis of a scan lens of the SS-OCT apparatus according to some embodiments. According to some embodiments, the Fourier transform is used as a sparsifying transform to transform the two-dimensional depth profile to a sparse representation 500B of the two-dimensional depth profile. FIG. 5B includes a sparse representation 500B of the two-dimensional depth profile 500A in FIG. 5A obtained by applying the Fourier transform. Although the two-dimensional depth profile is not able to be directly extracted from only a portion of the two-dimensional interference signal using normal means, because the sparse representation of the depth profile is sparse, the two-dimensional depth profile is able to be extracted from a portion of the two-dimensional interference signal using compressed sensing, e.g., by using the LASSO in Equation (6),

$$min \frac{1}{2} {‖ {( A ⊗ B )}_{s} v - {w}_{s} ‖}_{2}^{2} + α {‖ v ‖}_{1} . \qquad ( 6 )$$

Here, v is the sparse representation of the depth profile flattened into a one-dimensional vector, w is the two-dimensional interference signal flattened into a one-dimensional vector, A is the inverse of the matrix that transforms the wavenumber axis of the two-dimensional interference signal to the depth domain, B is the inverse of the matrix that transforms the transverse axis of the two-dimensional interference signal to the sparse domain, and the subscript s denotes that only the elements corresponding to the portion of the two-dimensional interference signal obtained are present. An accurate two-dimensional depth profile is able to be reconstructed from the extracted sparse representation by applying the inverse of the sparsifying transform to the sparse representation. In some embodiments, the matrix that transforms the wavenumber axis of the two-dimensional interference signal to the depth domain is the uniform discrete Fourier transform matrix. In some embodiments, the matrix that transforms the wavenumber axis of the two-dimensional interference signal to the depth domain is the non-uniform discrete Fourier transform matrix. In some embodiments, the matrix that transforms the transverse axis of the two-dimensional interference signal to the sparse domain is the uniform discrete Fourier transform matrix. In some embodiments, the matrix that transforms the transverse axis of the two-dimensional interference signal to the sparse domain is the non-uniform discrete Fourier transform matrix. In some embodiments, the matrix that transforms the transverse axis of the two-dimensional interference signal to the sparse domain is the discrete cosine transform matrix. In some embodiments, the matrix that transforms the transverse axis of the two-dimensional interference signal to the sparse domain is a discrete wavelet transform matrix.

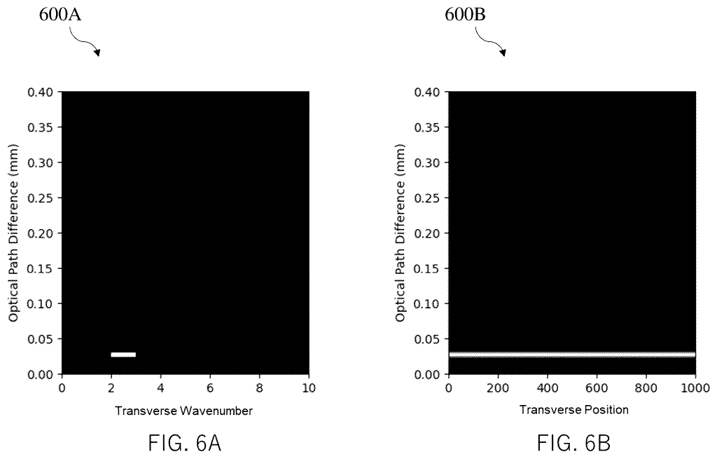

FIGS. 6A-6B indicate the use of compressed sensing to extract an accurate two-dimensional depth profile of a sample having an interface inclined relative to a plane transverse to an optical axis of a scan lens of a SS-OCT apparatus when a SGDBR laser used a light source is swept non-monotonically, according to FIG. 3C.

FIG. 6A is a view of a sparse representation 600A of a two-dimensional depth profile extracted by compressed sensing of a two-dimensional interference signal of a sample having an interface that is inclined relative to a plane transverse to an optical axis of a scan lens when an output wavelength of a wavelength-tunable laser used as a light source is swept with injection current sequences that have reduced sudden changes in current as a sample light beam is scanned in a transverse direction according to some embodiments. The extracted sparse representation 600A in FIG. 6A matches with the sparse representation 500B extracted directly from the full two-dimensional depth profile, as seen in FIG. 5B. The correspondence between the sparse representation 600A and the sparse representation 500B validates the extraction technique of this description. An apparent difference in magnitude of the plot in the sparse representation 600A relative to the plot in the spare representation 500B is due to the difference in scale along the x-axis of the sparse representations 600A and 500B. The x-axis in the sparse representation 500B covers a greater range, therefore, the size of the plot in the spare representation 500B is depicted as smaller despite being the same size as the sparse representation 600A.

FIG. 6B is a view of a two-dimensional depth profile 600B reconstructed from the sparse representation 600A extracted by compressed sensing of a two-dimensional depth profile of a sample having an interface that is inclined relative to a plane transverse to an optical axis of a scan lens when an output wavelength of a wavelength-tunable laser used as a light source is swept with injection current sequences that have minimal sudden changes in current as a sample light beam is scanned in a transverse direction according to some embodiments. The reconstructed depth profile 600B of FIG. 6B matches the true two-dimensional depth profile 500A of FIG. 5A that was directly obtained from the two-dimensional interference signal shown in FIG. 2A.

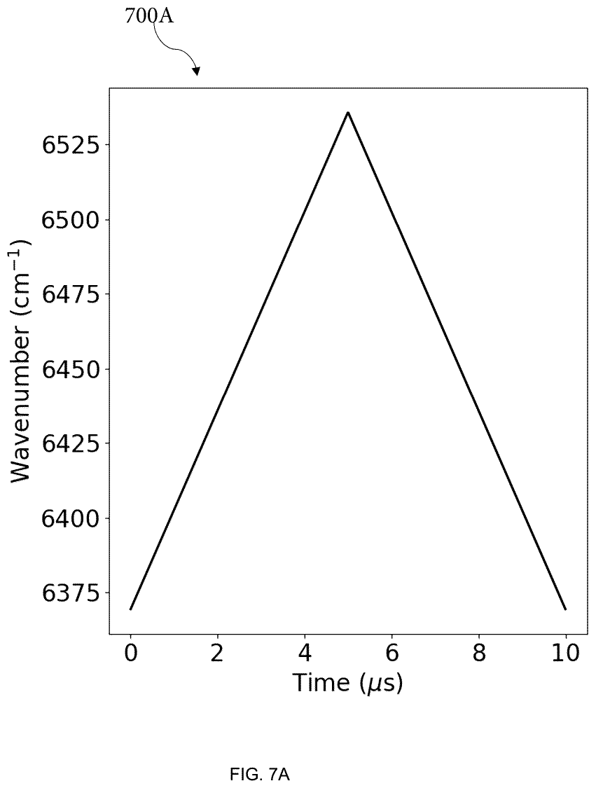

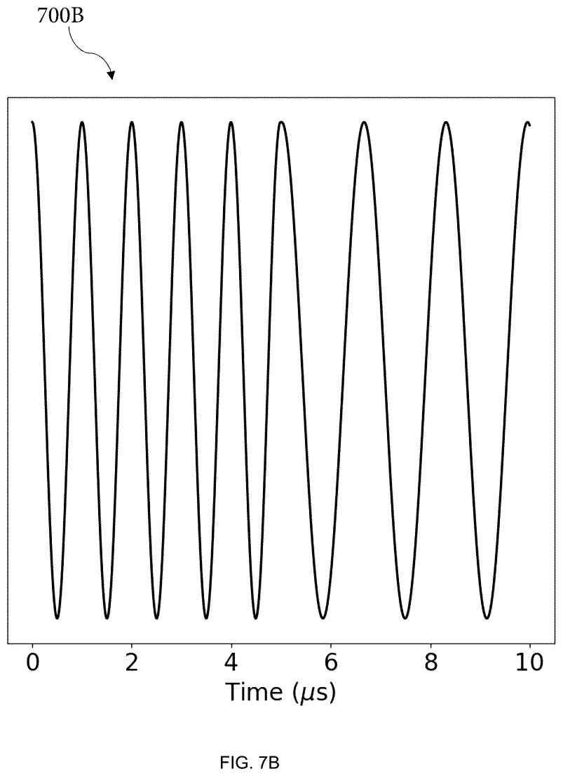

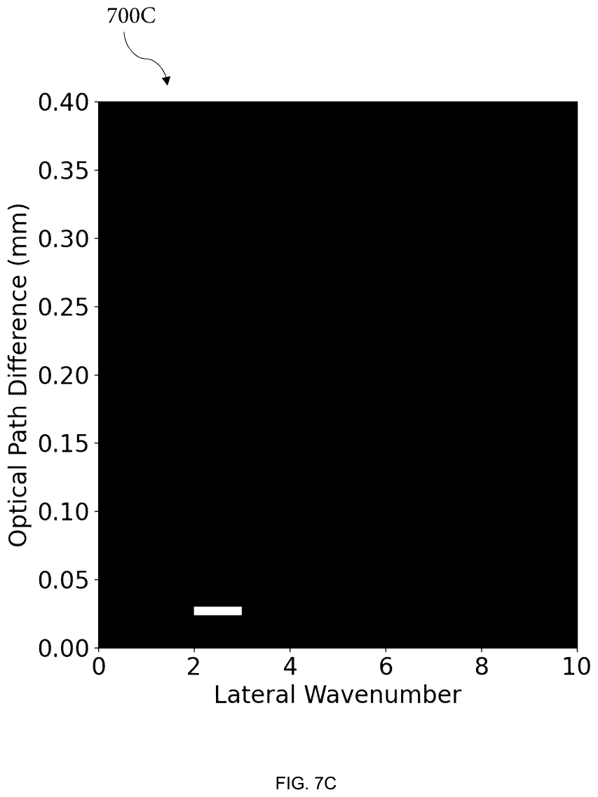

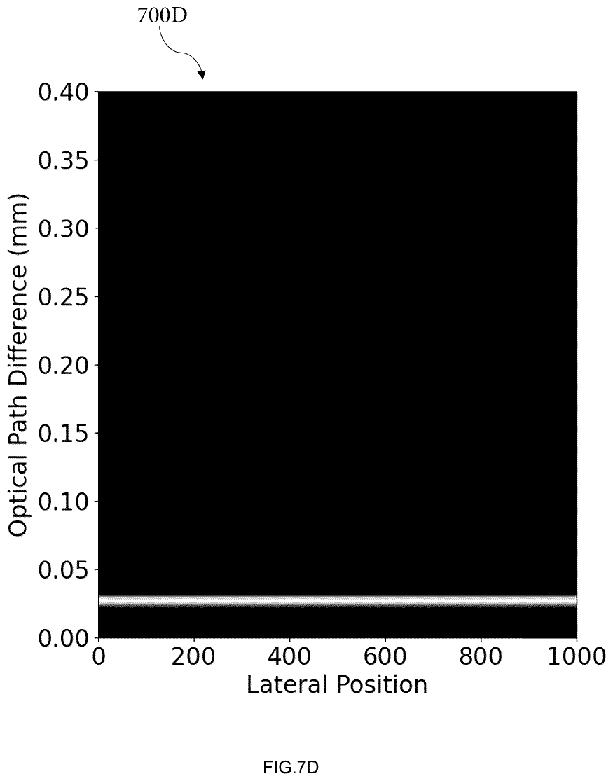

FIGS. 7A-7D provide at least one example of the reconstruction of a two-dimensional depth profile from an interference signal of a sample having an interface that is inclined relative to a plane transverse to an optical axis of a scan lens when the output wavelength of a light source of an SS-OCT apparatus is swept non-monotonically at the same time that a sample light beam is scanned in the transverse direction.

FIG. 7A is a view of the wavenumber of the output 700A of a light source with a tunable wavelength during a non-monotonic wavelength sweep where the wavenumber increases and decreases according to some embodiments. In some embodiments, the wavenumber of the output initially increases and then decreases. In some embodiments, the wavenumber of the output initially decreases and then increases. Such a wavelength sweep is achievable, for example, by using both the forward and backwards wavelength sweeps of a MEMS VCSEL laser or a SGDBR laser.

FIG. 7B is a view of an interference signal 700B obtained from a sample having an interface that is inclined relative to a plane transverse to an optical axis of a scan lens when a light source with a tunable wavelength is swept such that the wavenumber of an output initially increases and then decreases as a sample light beam is scanned in a transverse direction according to some embodiments. Similar to the preceding discussion, the interference signal 700B in FIG. 7B represents only a portion of the full two-dimensional interference signal of the sample, e.g., the two-dimensional interference signal 200A of FIG. 2A.

FIG. 7C is a view of a sparse representation 700C of a two-dimensional depth profile extracted by compressed sensing of a two-dimensional interference signal of a sample having an interface that is inclined relative to a plane transverse to an optical axis of a scan lens when a light source with a tunable wavelength is swept such that the wavenumber of an output increases and decreases as a sample light beam is scanned in a transverse direction according to some embodiments. When compressed sensing is applied according to some embodiments, the sparse representation 700C of FIG. 7C is able to be extracted. The sparse representation 700C matches the sparse representation 500B of FIG. 5B extracted directly from the true two-dimensional depth profile. The consistency of the sparse representation 700C of FIG. 7C and the sparse representation 500B of FIG. 5B demonstrates the accuracy of the extraction of this description.

FIG. 7D is a view of a two-dimensional depth profile 700D reconstructed from a sparse representation extracted by compressed sensing of a two-dimensional depth profile of a sample having an interface that is inclined relative to a plane transverse to an optical axis of a scan lens when a light source with a tunable wavelength is swept such that the wavenumber of an output increases and decreases as a sample light beam is scanned in a transverse direction according to some embodiments. By applying an inverse sparsifying transform, e.g., an inverse Fourier transform, an accurate two-dimensional depth profile 700D is reconstructed from the sparse representation 700C of FIG. 7C.

One of ordinary skill in the art would understand that the non-monotonic sweep sequences shown here are purely exemplary, and a range of different sweep sequences are within the scope of this description. Furthermore, one of ordinary skill in the art would understand that a variety of different sparsifying transforms are usable so long as a sparse signal is obtained when a sparsifying transform is applied to the depth profile of a particular sample. In some embodiments, the sparse transform is specific to a particular sample or type of sample. In some embodiments, the sparse transform is a transform that generally produces a sparse signal when applied to a depth profile of a generic sample. Whereas the two-dimensional depth profiles reconstructed in the examples provided here have the same number of elements in the transverse direction as the true two-dimensional depth profiles, one of ordinary skill in the art would understand that the reconstructed depth profiles are able to have different dimensions from the true two-dimensional depth profiles and that an inverse sparsifying transform that decreases or increases the transverse resolution is also usable.

FIG. 8 is a schematic view of a, SS-OCT apparatus 800 in accordance with some embodiments. The SS-OCT apparatus 800 is usable to obtain three-dimensional tomographic images of a sample 801. In accordance with some embodiments, for each point in the transverse plane of the sample 801, the wavelength of a wavelength-tunable light source 802 is swept non-monotonically over a wavelength range. The wavelength tunable light source 802 has an output light beam 803 that is received by a first optical coupler 804. The first optical coupler 804 splits the output light beam into a sample light beam 805 and a reference light beam 806. The sample light beam passes through an optical circulator 807 and is received by a sample illumination section 808. In some embodiments, the sample illumination section 808 is similar to the illumination section 100A of FIG. 1A. The sample illumination section 808 illuminates the sample 801 with the sample light beam 805 and scans the sample light beam 805 in at least one transverse direction on a transverse plane of the sample 801 while the wavelength of the wavelength-tunable light source 802 is being non-monotonically swept. The sample illumination section 808 then collects backscattered light from the sample 801 and generates a backscattered light beam 809. A second optical coupler 810 receives the backscattered light beam 809 and the reference light beam 806. The second optical coupler 810 interferes the backscattered light beam 809 with the reference light beam 806 to produce an optical interference signal 811. The optical interference signal 811 is detected by a detector 812 which outputs an electrical interference signal 813. A controller 814 receives the electrical interference signal 813, and in accordance with the description provided in the preceding, the controller extracts a two-dimensional depth profile of the sample 801 in the vicinity of a single point in the transverse plane of the sample. The sample illumination section 808 scans the sample light beam to a plurality of points in the transverse plane of the sample and concatenates the two-dimensional depth profiles in the vicinities of the plurality of points to form a three-dimensional tomographic image of the depth profile of the sample 801. In some embodiments, the controller 814 also control the light source 802 to non-monotonically sweep the wavelength of the light source 802.

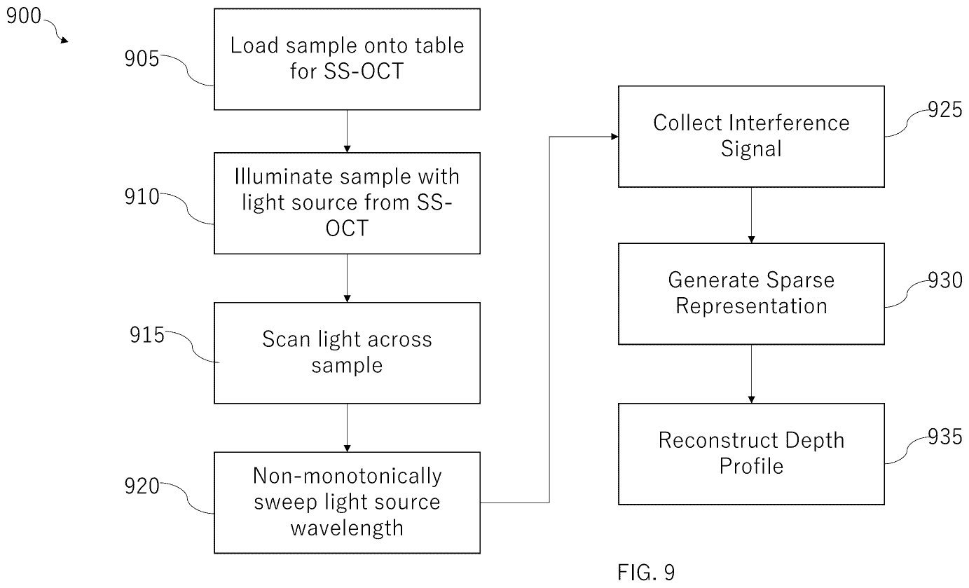

FIG. 9 is a flowchart of a method 900 of using an SS-OCT apparatus to determine a depth profile in accordance with some embodiments. In some embodiments, the method 900 is usable with the SS-OCT apparatus 800 (FIG. 8). In some embodiments, the method 900 is usable with an SS-OCT apparatus other than the SS-OCT apparatus 800 (FIG. 8).

In operation 905, a sample is loaded onto a table for the SS-OCT apparatus. In some embodiments, the sample includes a surface that is inclined with respect to a transverse plane of an illumination section of the SS-OCT apparatus. In some embodiments, the sample is held on the table using a vacuum. In some embodiments, the sample is held on the table using one or more mechanical fixtures, such as a clamp.

In operation 910, the sample is illuminated with a light source from the SS-OCT apparatus. The light source includes a tunable light source. In some embodiments, the light source is a tunable laser light source. In some embodiments, the light source includes a SGDBR laser. In some embodiments, the light source includes a MEMS VCSEL laser. In some embodiments, the light source includes a plurality of light sources. In some embodiments, each of the plurality of light sources capable of independent activation and tuning based on a signal from a controller, e.g., controller 814 (FIG. 8).

In operation 915, the light from the light source is scanned across the sample. In some embodiments, the light is scanned across the sample by moving the sample relative to the light. In some embodiments, the table is moveable relative to the light, e.g., using one or more motors, such as a stepper motor, a piezoelectric motor, etc. In some embodiments, the table is moveable in one dimension transverse to a plane of the light incident on the sample. In some embodiments, the table is moveable in two dimensions transverse to the plane of the light incident on the sample. In some embodiments, the light is scanned across the sample by moving the optical components of the SS-OCT apparatus relative to the sample. In some embodiments, the optical components are configured to cause the light to move in one dimension transverse to a plane of the sample. In some embodiments, the optical components are configured to cause the light to move in two dimensions transverse to the plane of the sample. In some embodiments, the optical components are moved using a motor, such as a stepper motor, a piezoelectric motor, etc.

In operation 920, a wavelength of the light source is swept non-monotonically. In some embodiments, the operation 920 is implemented simultaneously with the operation 915. In some embodiments, the operation 920 and the operation 915 are repeated multiple times while the light is moved across the surface of the sample. In some embodiments, the light source is controlled by a controller, e.g., controller 814 (FIG. 8), to non-monotonically sweep the output wavelength of the light source. In some embodiments, the wavelength of the light source is swept in a manner resembling the wavenumber output 700A (FIG. 7A).

In operation 925, an interference signal is collected by the SS-OCT apparatus. The interference signal is collected by interfering light backscattered by the sample with a reference beam from the light source. In some embodiments, the interference signal resembles the interference signal 700B (FIG. 7B)

In operation 930, a sparse representation of the interference signal is generated. The sparse representation is generated using compressed sensing and a sparsifying transform, e.g., by using the LASSO in Equation (6),

$$min \frac{1}{2} {‖ {( A ⊗ B )}_{s} v - {w}_{s} ‖}_{2}^{2} + α {‖ v ‖}_{1} . \qquad ( 6 )$$

Here, v is the sparse representation of the depth profile flattened into a one-dimensional vector, w is the two-dimensional interference signal flattened into a one-dimensional vector, A is the inverse of the matrix that transforms the wavenumber axis of the two-dimensional interference signal to the depth domain, B is the inverse of the matrix that transforms the transverse axis of the two-dimensional interference signal to the sparse domain, and the subscript s denotes that only the elements corresponding to the portion of the two-dimensional interference signal obtained are present. The inverse of the sparsifying transform B is then applied to the sparse approximation to obtain the two-dimensional depth profile. According to some embodiments, the Fourier transform is used as the sparsifying transform.

In operation 935, a depth profile is reconstructed using the sparse representation. An accurate two-dimensional depth profile is able to be reconstructed from the extracted sparse representation by applying the inverse of the sparsifying transform to the sparse representation. In some embodiments, the inverse of the sparsifying transform is the inverse Fourier transform.

One of ordinary skill in the art would understand that the operations described with respect to method 900 are merely exemplary. In some embodiments, the method 900 includes additional operations. For example, in some embodiments, the method 900 further includes illuminating the sample with light from a second light source. In some embodiments, at least one of the operations of the method 900 is omitted. For example, in some embodiments, the operation 905 is omitted where the SS-OCT apparatus is mounted on or around a sample. In some embodiments, an order of operations of the method 900 is adjusted. For example, in some embodiments, operation 910 is performed simultaneously with operation 920 and after operation 915.

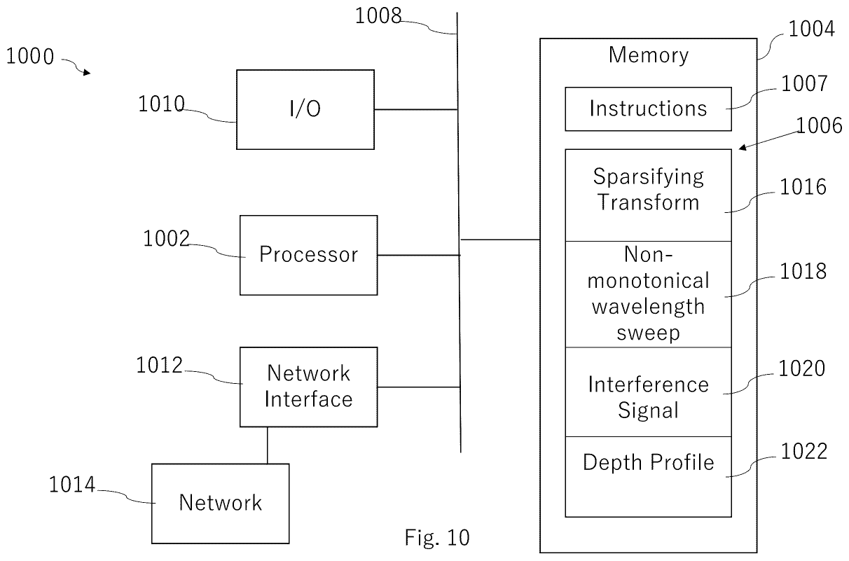

FIG. 10 is a schematic view of a controller 1000 for extracting a depth profile based on information from an SS-OCT apparatus in accordance with some embodiments. Controller 1000 includes a hardware processor 1002 and a non-transitory, computer readable storage medium 1004 encoded with, i.e., storing, the computer program code 1006, i.e., a set of executable instructions. Computer readable storage medium 1004 is also encoded with instructions 1007 for interfacing with external devices. The processor 1002 is electrically coupled to the computer readable storage medium 1004 via a bus 1008. The processor 1002 is also electrically coupled to an input/output (I/O) interface 1010 by bus 1008. A network interface 1012 is also electrically connected to the processor 1002 via bus 1008. Network interface 1012 is connected to a network 1014, so that processor 1002 and computer readable storage medium 1004 are capable of connecting to external elements via network 1014. The processor 1002 is configured to execute the computer program code 1006 encoded in the computer readable storage medium 1004 in order to cause controller 1000 to be usable for performing a portion or all of the operations as described in with respect to the SS-OCT apparatus 800 (FIG. 8), method 900 (FIG. 9), or other suitable SS-OCT apparatuses or methods.

In some embodiments, the processor 1002 is a central processing unit (CPU), a multi-processor, a distributed processing system, an application specific integrated circuit (ASIC), Field Programmable Gate Array (FPGA), and/or a suitable processing unit.

In some embodiments, the computer readable storage medium 1004 is an electronic, magnetic, optical, electromagnetic, infrared, and/or a semiconductor system (or apparatus or device). For example, the computer readable storage medium 1004 includes a semiconductor or solid-state memory, a magnetic tape, a removable computer diskette, a random access memory (RAM), a read-only memory (ROM), a rigid magnetic disk, and/or an optical disk. In some embodiments using optical disks, the computer readable storage medium 1004 includes a compact disk-read only memory (CD-ROM), a compact disk-read/write (CD-R/W), and/or a digital video disc (DVD).

In some embodiments, the storage medium 1004 stores the computer program code 1006 configured to cause controller 1000 to perform a portion or all of the operations as described in with respect to the SS-OCT apparatus 800 (FIG. 8), method 900 (FIG. 9), or other suitable SS-OCT apparatuses or methods. In some embodiments, the storage medium 1004 also stores information used for performing a portion or all of the operations as described in with respect to the SS-OCT apparatus 800 (FIG. 8), method 900 (FIG. 9), or other suitable SS-OCT apparatuses or methods; as well as information generated during performing a portion or all of the operations as described in with respect to the SS-OCT apparatus 800 (FIG. 8), method 900 (FIG. 9), or other suitable SS-OCT apparatuses or methods. In some embodiments, the information includes a sparsifying transform parameter 1016, a non-monotonical wavelength sweep parameter 1018, an interference signal parameter 1020, a depth profile parameter 1022, and/or a set of executable instructions to perform the operation of a portion or all of the operations as described in with respect to the SS-OCT apparatus 800 (FIG. 8), method 900 (FIG. 9), or other suitable SS-OCT apparatuses or methods.

In some embodiments, the storage medium 1004 stores instructions 1007 for interfacing with external devices. The instructions 1007 enable processor 1002 to generate instructions readable by the external devices to effectively implement a portion or all of the operations as described in with respect to the SS-OCT apparatus 800 (FIG. 8), method 900 (FIG. 9), or other suitable SS-OCT apparatuses or methods.

Controller 1000 includes I/O interface 1010. I/O interface 1010 is coupled to external circuitry. In some embodiments, I/O interface 1010 includes a keyboard, keypad, mouse, trackball, trackpad, and/or cursor direction keys for communicating information and commands to processor 1002.

Controller 1000 also includes network interface 1012 coupled to the processor 1002. Network interface 1012 allows controller 1000 to communicate with network 1014, to which one or more other computer systems are connected. Network interface 1012 includes wireless network interfaces such as BLUETOOTH, WIFI, WIMAX, GPRS, or WCDMA; or wired network interface such as ETHERNET, USB, or IEEE-1394. In some embodiments, a portion or all of the operations as described in with respect to the SS-OCT apparatus 800 (FIG. 8), method 900 (FIG. 9), or other suitable SS-OCT apparatuses or methods implemented in two or more controllers 100, and information such as sparsifying transform, non-monotonical wavelength sweep, interference signal, and depth profile are exchanged between different controllers 1000 via network 1014.

An aspect of this description relates to a swept-source optical coherence tomography (SS-OCT) apparatus. The SS-OCT apparatus includes a wavelength-tunable light source. The SS-OCT apparatus includes a first optical coupler configured to split an output of the wavelength-tunable light source into a reference light beam and a sample light beam. The SS-OCT apparatus includes a sample illumination section configured to illuminate a sample using the sample beam, and receive a backscattered sample light beam that is backscattered from the sample. The SS-OCT apparatus includes a second optical coupler configured to receive the reference light beam and the backscattered sample light beam, wherein the second optical coupler is configured to output an optical interference signal. The SS-OCT apparatus further includes a detector configured to convert the optical interference signal to an electrical interference signal. The SS-OCT apparatus further includes a controller configured to receive the electrical interference signal, generate a sparse representation based on the received electrical signal, and generate a depth profile of the sample by applying compressed sensing to the sparse representation. In some embodiments, the wavelength-tunable light source comprises a semiconductor wavelength-tunable laser. In some embodiments, the controller is further configured to non-monotonically sweep an output wavelength of the wavelength-tunable light source. In some embodiments, the controller is configured to non-monotonically sweep the output wavelength of the wavelength-tunable light source by injecting a sequence of changes in current into the semiconductor wavelength-tunable laser. In some embodiments, the controller is configured to apply compressed sensing by finding the sparse representation v that minimizes a least-absolute shrinkage and selection operator (LASSO) described by,

$$min \frac{1}{2} {‖ {( A ⊗ B )}_{s} v - {w}_{s} ‖}_{2}^{2} + α {‖ v ‖}_{1}$$

where wₛ is a measured interference signal vector, A is a first transform matrix that transforms a first, depth axis of the sparse representation from a depth domain to a wavenumber domain, B is a second transform matrix that transforms a second, transverse wavenumber axis of the sparse representation from a transverse wavenumber domain to a transverse position domain, and a is a constant Lagrangian multiplier. In some embodiments, the first transform matrix is the uniform discrete Fourier transform matrix. In some embodiments, the first transform matrix is the non-uniform discrete Fourier transform matrix. In some embodiments, the second transform matrix is the uniform discrete Fourier transform matrix. In some embodiments, the second transform matrix is the non-uniform discrete Fourier transform matrix. In some embodiments, the second transform matrix is the discrete cosine transform matrix. In some embodiments, the second transform matrix is a discrete wavelet transform matrix.

An aspect of this description relates to a swept-source optical coherence tomography (SS-OCT) apparatus. The SS-OCT apparatus includes a wavelength-tunable light source. The SS-OCT apparatus further includes a first optical coupler configured to split an output of the wavelength-tunable light source into a reference light beam and a sample light beam. The SS-OCT apparatus further includes a sample illumination section configured to illuminate a sample using the sample beam, and receive a backscattered sample light beam that is backscattered from the sample. The SS-OCT apparatus further includes a second optical coupler configured to receive the reference light beam and the backscattered sample light beam, wherein the second optical coupler is configured to output an optical interference signal. The SS-OCT apparatus further includes a detector configured to convert the optical interference signal to an electrical interference signal. The SS-OCT apparatus further includes a controller configured to receive the electrical interference signal, and non-monotonically sweep an output wavelength of the wavelength-tunable light source. In some embodiments, the controller is configured to generate a sparse representation based on the received electrical signal, and generate a depth profile of the sample by applying compressed sensing to the sparse representation. In some embodiments, the controller is configured to apply compressed sensing by finding the sparse representation v that minimizes a least-absolute shrinkage and selection operator (LASSO) described by,

$$min \frac{1}{2} {‖ {( A ⊗ B )}_{s} v - {w}_{s} ‖}_{2}^{2} + α {‖ v ‖}_{1}$$

where wₛ is a measured interference signal vector, A is a first transform matrix that transforms a first, depth axis of the sparse representation from a depth domain to a wavenumber domain, B is a second transform matrix that transforms a second, transverse wavenumber axis of the sparse representation from a transverse wavenumber domain to a transverse position domain, and a is a constant Lagrangian multiplier. In some embodiments, the controller is configured to non-monotonically sweep the output wavelength of the wavelength-tunable light source by injecting a sequence of changes in current into the semiconductor wavelength-tunable laser.

An aspect of this description relates to a method of using a swept-source optical coherence tomography (SS-OCT) apparatus. The method includes outputting a beam using a wavelength-tunable light source. The method further includes splitting the beam into a reference light beam and a sample light beam. The method further includes illuminating a sample using the sample beam. The method further includes receiving a backscattered sample light beam that is backscattered from the sample. The method further includes interfering the reference light beam and the backscattered sample light beam to form an optical interference signal. The method further includes converting the optical interference signal to an electrical interference signal. The method further includes generating a sparse representation based on the electrical signal using compressed sensing. The method further includes generating a depth profile based on the sparse representation. In some embodiments, the method further includes non-monotonically sweeping an output wavelength of the wavelength-tunable light source. In some embodiments, non-monotonically sweeping the output wavelength includes non-monotonically sweeping the output wavelength by injecting a sequence of changes in current into the semiconductor wavelength-tunable laser. In some embodiments, applying compressed sensing comprises applying compressed sensing by finding the sparse representation v that minimizes a least-absolute shrinkage and selection operator (LASSO) described by,

$$min \frac{1}{2} {‖ {( A ⊗ B )}_{s} v - {w}_{s} ‖}_{2}^{2} + α {‖ v ‖}_{1}$$

where wₛ is a measured interference signal vector, A is a first transform matrix that transforms a first, depth axis of the sparse representation from a depth domain to a wavenumber domain, B is a second transform matrix that transforms a second, transverse wavenumber axis of the sparse representation from a transverse wavenumber domain to a transverse position domain, and a is a constant Lagrangian multiplier. In some embodiments, the second transform matrix is a uniform discrete Fourier transform matrix, a non-uniform discrete Fourier transform matrix, a discrete cosine transform matrix, or a discrete wavelet transform matrix.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A swept-source optical coherence tomography (SS-OCT) apparatus comprising:
a wavelength-tunable light source;
a first optical coupler configured to split an output of the wavelength-tunable light source into a reference light beam and a sample light beam;
a sample illumination section configured to:
illuminate a sample using the sample beam, and
receive a backscattered sample light beam that is backscattered from the sample;
a second optical coupler configured to receive the reference light beam and the backscattered sample light beam, wherein the second optical coupler is configured to output an optical interference signal;
a detector configured to convert the optical interference signal to an electrical interference signal; and
a controller configured to:
receive the electrical interference signal,
generate a sparse representation based on the received electrical signal, and
generate a depth profile of the sample by applying compressed sensing to the sparse representation.

2. The SS-OCT apparatus according to claim 1, wherein the wavelength-tunable light source comprises a semiconductor wavelength-tunable laser.

3. The SS-OCT apparatus according to claim 1, wherein the controller is further configured to non-monotonically sweep an output wavelength of the wavelength-tunable light source.

4. The SS-OCT apparatus according to claim 3, wherein the controller is configured to non-monotonically sweep the output wavelength of the wavelength-tunable light source by injecting a sequence of changes in current into the semiconductor wavelength-tunable laser.

5. The SS-OCT apparatus according to claim 1, wherein the controller is configured to apply compressed sensing by:
finding the sparse representation v that minimizes a least-absolute shrinkage and selection operator (LASSO) described by,
$$min \frac{1}{2} {‖ {( A ⊗ B )}_{s} v - {w}_{s} ‖}_{2}^{2} + α {‖ v ‖}_{1}$$
where wₛ is a measured interference signal vector, A is a first transform matrix that transforms a first, depth axis of the sparse representation from a depth domain to a wavenumber domain, B is a second transform matrix that transforms a second, transverse wavenumber axis of the sparse representation from a transverse wavenumber domain to a transverse position domain, and a is a constant Lagrangian multiplier.

6. The SS-OCT apparatus according to claim 5, wherein the first transform matrix is the uniform discrete Fourier transform matrix.

7. The SS-OCT apparatus according to claim 5, wherein the first transform matrix is the non-uniform discrete Fourier transform matrix.

8. The SS-OCT apparatus according to claim 5, wherein the second transform matrix is the uniform discrete Fourier transform matrix.

9. The SS-OCT apparatus according to claim 5, wherein the second transform matrix is the non-uniform discrete Fourier transform matrix.

10. The SS-OCT apparatus according to claim 5, wherein the second transform matrix is the discrete cosine transform matrix.

11. The SS-OCT apparatus according to claim 5, wherein the second transform matrix is a discrete wavelet transform matrix.

12. A swept-source optical coherence tomography (SS-OCT) apparatus comprising:
a wavelength-tunable light source;
a first optical coupler configured to split an output of the wavelength-tunable light source into a reference light beam and a sample light beam;
a sample illumination section configured to:
illuminate a sample using the sample beam, and
receive a backscattered sample light beam that is backscattered from the sample;
a second optical coupler configured to receive the reference light beam and the backscattered sample light beam, wherein the second optical coupler is configured to output an optical interference signal;
a detector configured to convert the optical interference signal to an electrical interference signal; and
a controller configured to:
receive the electrical interference signal, and
non-monotonically sweep an output wavelength of the wavelength-tunable light source.

13. The SS-OCT apparatus according to claim 12, wherein the controller is configured to:
generate a sparse representation based on the received electrical signal, and
generate a depth profile of the sample by applying compressed sensing to the sparse representation.

14. The SS-OCT apparatus according to claim 13, wherein the controller is configured to apply compressed sensing by:
finding the sparse representation v that minimizes a least-absolute shrinkage and selection operator (LASSO) described by,
$$min \frac{1}{2} {‖ {( A ⊗ B )}_{s} v - {w}_{s} ‖}_{2}^{2} + α {‖ v ‖}_{1}$$
where wₛ is a measured interference signal vector, A is a first transform matrix that transforms a first, depth axis of the sparse representation from a depth domain to a wavenumber domain, B is a second transform matrix that transforms a second, transverse wavenumber axis of the sparse representation from a transverse wavenumber domain to a transverse position domain, and a is a constant Lagrangian multiplier.

15. The SS-OCT apparatus according to claim 12, wherein the controller is configured to non-monotonically sweep the output wavelength of the wavelength-tunable light source by injecting a sequence of changes in current into the semiconductor wavelength-tunable laser.

16. A method of using a swept-source optical coherence tomography (SS-OCT) apparatus, the method includes:
outputting a beam using a wavelength-tunable light source;
splitting the beam into a reference light beam and a sample light beam;
illuminating a sample using the sample beam;
receiving a backscattered sample light beam that is backscattered from the sample;
interfering the reference light beam and the backscattered sample light beam to form an optical interference signal;
converting the optical interference signal to an electrical interference signal;
generating a sparse representation based on the electrical signal, and
generating a depth profile of the sample by applying compressed sensing to the sparse representation.

17. The method according to claim 16, further comprising non-monotonically sweeping an output wavelength of the wavelength-tunable light source.

18. The method according to claim 17, wherein non-monotonically sweeping the output wavelength comprises non-monotonically sweeping the output wavelength by injecting a sequence of changes in current into the semiconductor wavelength-tunable laser.

19. The method according to claim 16, wherein applying compressed sensing comprises applying compressed sensing by:
finding the sparse representation v that minimizes a least-absolute shrinkage and selection operator (LASSO) described by,
$$min \frac{1}{2} {‖ {( A ⊗ B )}_{s} v - {w}_{s} ‖}_{2}^{2} + α {‖ v ‖}_{1}$$
where wₛ is a measured interference signal vector, A is a first transform matrix that transforms a first, depth axis of the sparse representation from a depth domain to a wavenumber domain, B is a second transform matrix that transforms a second, transverse wavenumber axis of the sparse representation from a transverse wavenumber domain to a transverse position domain, and a is a constant Lagrangian multiplier.

20. The method according to claim 19, wherein the second transform matrix is a uniform discrete Fourier transform matrix, a non-uniform discrete Fourier transform matrix, a discrete cosine transform matrix, or a discrete wavelet transform matrix.
